(19) United States
(12) Patent Application Publication
(10) Pub. No.: US 2026/0169854 A1
(43) Pub. Date: Jun. 18, 2026

(54) Handling Uncorrectable Errors in Memory

(71) Applicants: Advanced Micro Devices, Inc, Santa Clara, CA (US); ATI Technologies ULC, Markham (CA)

(72) Inventors: Chong Zhang, Shanghai (CN); Vilas K. Sridharan, Jamaica Plain, MA (US); Tao Zhou, Shanghai (CN); Maroun Marco Gabra, Newmarket (CA); Costas A. Argyrides, Lago Vista, TX (US); Hong Yang, Shanghai (CN); CanYue Li, Shanghai (CN); YiPeng Chai, Shanghai (CN)

(21) Appl. No.: 18/568,475

(22) PCT Filed: Mar. 16, 2023
(86) PCT No.: PCT/CN2023/081877

§ 371 Date: Dec. 8, 2023

(51) Int. Cl. G06F 11/10

(52) U.S. Cl. CPC G06F 11/1048

(57) ABSTRACT

Handling uncorrectable errors in memory is described. In accordance with the described techniques, a system includes a memory, a processor, and an interrupt handler. The memory detects an uncorrectable error in a portion of the memory and issues an interrupt request. The processor converts the uncorrectable error to a deferred error responsive to receiving the interrupt request issued by the memory. The interrupt handler identifies the process that accesses the uncorrectable error in the portion of the memory and handles the uncorrectable error by terminating the process that accesses the uncorrectable error. In one or more implementations, the interrupt handler terminates the process that accesses the uncorrectable error without terminating other processes that are not accessing the uncorrectable error in the portion of the memory.

### RELATED APPLICATION

This application claims priority to International Application No. PCT/CN2023/081877, filed Mar. 16, 2023, entitled “Handling Uncorrectable Errors in Memory,” the entire disclosure of which is hereby incorporated by reference herein in its entirety.

### BACKGROUND

Uncorrectable errors in memory refer to errors that cannot be fixed by the memory subsystem. These errors are typically caused by physical defects in the memory hardware or by electrical interference that corrupts data as it is being stored or retrieved. For example, uncorrectable errors in memory can be caused by various events such as a stuck bit, a particle strike (e.g., due to background radiation including neutrons from cosmic ray secondaries), and so forth. Faults in the memory due to such events can be permanent, intermittent, and/or transient, such as across nodes in data centers. Additionally, multi-bit faults in DRAM due to such events can be permanent. In many cases, uncorrectable memory errors can cause system crashes, data corruption, or other serious problems that can lead to data loss or system downtime.

### BRIEF DESCRIPTION OF THE DRAWINGS

FIG. 1 is a block diagram of a non-limiting example system having an interrupt handler that handles uncorrectable errors in memory.

FIG. 2 depicts a procedure in an example implementation of handling uncorrectable errors in memory.

FIG. 3 depicts a procedure in another example implementation of handling uncorrectable errors in memory.

FIG. 4 depicts a procedure in another example implementation of handling uncorrectable errors in memory.

FIG. 5 depicts a procedure in another example implementation of handling uncorrectable errors in memory.

### DETAILED DESCRIPTION

### Overview

In conventional approaches, when an uncorrectable error is detected in memory, those errors are treated as fatal events. For instance, conventional systems freeze data paths to prevent corrupted data from escaping a hardware device, e.g., a processor. Additionally or alternatively, the drivers of conventional systems issue a complete reset of the processor to return the processor to a fully working state and/or cause a warm reboot of the system. Conventionally configured drivers also identify the portions of memory (e.g., the pages) where the uncorrectable errors are located and retire those portions from being used. Due to such operations, conventional approaches cause all the applications running on top of the processor to be terminated, and in order to resume those applications, they need to be restarted after the processor is returned to an operating state.

To overcome these problems, handling uncorrectable errors in memory is described. In contrast to these conventional approaches, the described techniques do not require all the applications and/or processes to be terminated responsive to an uncorrectable error in the memory. Instead, an improved interrupt handler limits the impact of uncorrectable errors to the processes that consume the portion of memory where the uncorrectable error is located by converting the uncorrectable error to a “deferred” error rather than a fatal error. This enables the system to continue executing the processes that consume portions of memory where uncorrectable errors are not located.

After converting the uncorrectable error to a deferred error, the memory is monitored and the interrupt handler identifies which process accesses (e.g., consumes) the portion of the memory having the uncorrectable error which has been marked as a deferred error. In one or more implementations, for instance, the interrupt handler causes a look-up for an identifier (e.g., in a record of interrupts), where the identifier identifies an address space of the memory allocated to a process. Once the process that accesses the uncorrectable error marked as the deferred error is identified, the interrupt handler causes termination of the process.

Notably, the interrupt handler causes termination of the process without terminating other processes, e.g., without terminating the other processes that are not accessing portions of the memory with an uncorrectable error marked as a deferred error. Once the process consuming the uncorrectable error is terminated, a recovery process is initiated. In one or more implementations, the particular recovery process initiated by the interrupt handler is based on a type of process that accessed (e.g., consumed) the portion of memory with the uncorrectable error marked as deferred. In one or more implementations, for instance, the recovery process initiated depends on whether the process corresponds to a compute engine, a direct memory access (DMA) engine, or a multimedia engine, to name a few.

Thus, as compared to conventional approaches, the described techniques enable critical tasks and processes to continue to execute even when an uncorrectable error is detected. Rather than terminating all processes, for example, just the process that accesses the uncorrectable error is terminated, while other processes keep running and do not need to be interrupted or terminated.

In some aspects, the techniques described herein relate to a system including: a memory to detect an uncorrectable error in a portion of the memory and issue an interrupt request, a processor to convert the uncorrectable error to a deferred error responsive to receiving the interrupt request issued by the memory, and an interrupt handler to identify a process that accesses the uncorrectable error in the portion of the memory and handle the uncorrectable error by terminating the process that accesses the uncorrectable error.

In some aspects, the techniques described herein relate to a system, wherein the interrupt handler terminates the process that accesses the uncorrectable error without terminating other processes that are not accessing the uncorrectable error in the portion of the memory.

In some aspects, the techniques described herein relate to a system, wherein the processer converts the uncorrectable error to the deferred error by marking the uncorrectable error as a deferred error.

In some aspects, the techniques described herein relate to a system, wherein the interrupt handler identifies the process that accesses the uncorrectable error by causing a look-up for an identifier in a record of interrupts, wherein the identifier identifies an address space of the memory allocated to respective processes.

In some aspects, the techniques described herein relate to a system, wherein the interrupt handler terminates the process by providing a signal to a user mode driver to terminate the process.

In some aspects, the techniques described herein relate to a system, wherein the interrupt handler is further configured to initiate a recovery process after terminating the process that accesses the uncorrectable error.

In some aspects, the techniques described herein relate to a system, wherein the interrupt handler is further configured to select the recovery process from a plurality of recovery processes based on a type of the process that accessed the uncorrectable error.

In some aspects, the techniques described herein relate to a method including: detecting an uncorrectable error in a portion of a memory of a system, deferring handling of the uncorrectable error, identifying a process executed by a processor that accesses the uncorrectable error in the portion of the memory, and handling the uncorrectable error by terminating the process that accesses the uncorrectable error.

In some aspects, the techniques described herein relate to a method, wherein the deferring includes converting the uncorrectable error into a deferred error by marking the uncorrectable error.

In some aspects, the techniques described herein relate to a method, wherein the handling includes terminating the process that is accessing the uncorrectable error without terminating other processes that are not accessing the uncorrectable error in the portion of the memory.

In some aspects, the techniques described herein relate to a method, wherein the identifying includes causing a look-up for an identifier in a record of interrupts, wherein the identifier identifies an address space of the memory allocated to respective processes.

In some aspects, the techniques described herein relate to a method, further including initiating a recovery process to recover portions of the processor executing the process.

In some aspects, the techniques described herein relate to a method, wherein recovery process is selected from a plurality of recovery processes based on a type of the process that accessed the uncorrectable error.

In some aspects, the techniques described herein relate to a method, wherein the process is associated with a compute engine, and wherein the recovery process includes: stopping execution of one or more computing operations associated with the process associated with the compute engine; removing mappings of user mode queues assigned to the process associated with the compute engine for command submission; and reestablishing the mappings to the user mode queues so that the user mode queues are subsequently accessible to be assigned to the process associated with the compute engine.

In some aspects, the techniques described herein relate to a method, wherein if removal or reestablishment of the mappings fail, issuing a lightweight reset to cause the compute engine to be reset and reinitialized so that the compute engine is capable of submitting instructions.

In some aspects, the techniques described herein relate to a method, wherein the process is associated with a direct memory access engine, and wherein the recovery process includes causing a hardware reinitialization of a system direct memory access instance that accessed the portion of the memory with the uncorrectable error, and wherein if the hardware reinitialization of the system direct memory access instance fails, issuing a lightweight reset to cause the direct memory access engine to be reset and reinitialized so that the direct memory access engine is subsequently capable of submitting instructions.

In some aspects, the techniques described herein relate to a method, wherein the process is associated with a multimedia engine, and wherein the recovery process includes reinitializing the multimedia engine that accessed the portion of the memory with the uncorrectable error, and wherein if the reinitialization of the multimedia engine fails, issuing a lightweight reset to cause the multimedia engine to be reset and reinitialized so that the multimedia engine is capable of submitting instructions.

In some aspects, the techniques described herein relate to a method including: identifying a process that accesses a portion of a memory with an uncorrectable error marked as deferred, terminating the process without terminating other processes that are not accessing the uncorrectable error in the portion of the memory, and selecting a recovery process from a plurality of recovery processes based on a type of the process.

In some aspects, the techniques described herein relate to a method, wherein the process is associated with a compute engine, and wherein the recovery process includes: stopping execution of one or more computing operations associated with the process associated with the compute engine; removing mappings of user mode queues assigned to the process associated with the compute engine for command submission; and reestablishing the mappings to the user mode queues so that the user mode queues are subsequently accessible to be assigned to the process associated with the compute engine.

In some aspects, the techniques described herein relate to a method, wherein the process is associated with a direct memory access engine, and wherein the recovery process includes causing a hardware reinitialization of a system direct memory access instance that accessed the portion of the memory with the uncorrectable error, and wherein if the hardware reinitialization of the system direct memory access instance fails, issuing a lightweight reset to cause the direct memory access engine to be reset and reinitialized so that the direct memory access engine is subsequently capable of submitting instructions.

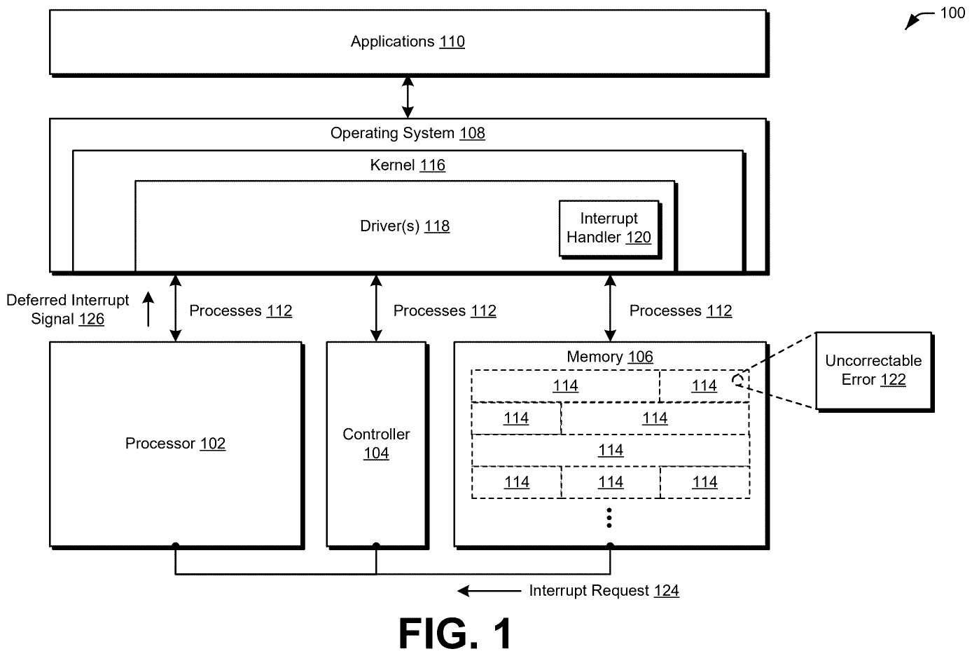

FIG. 1 is a block diagram of a non-limiting example system 100 having an interrupt handler that handles uncorrectable errors in memory. In particular, the system 100 includes a processor 102, controller 104, and memory 106. In accordance with the described techniques, the processor 102, the controller 104, and the memory 106 are coupled to one another via one or more wired or wireless connections.

Example wired connections include, but are not limited to, traces, system buses, interconnects, and planes, connecting two or more of the processor 102, the controller 104, and the memory 106. Examples of devices or apparatuses in which the system 100 is implemented include, but are not limited to, a personal computer (e.g., a desktop or tower computer), a server, a networking device, a smartphone or other wireless phone, a tablet or phablet computer, a notebook computer, a laptop computer, a wearable device (e.g., a smartwatch, an augmented reality headset or device, a virtual reality headset or device, a medical device), an entertainment device (e.g., a gaming console, a portable gaming device, a streaming media player, a digital video recorder, a music or other audio playback device, a television, a set-top box), an Internet of Things (IoT) device, a vehicle (e.g., an automotive computer), a system-on-chip (SoC), and other computing devices or systems.

The processor 102 is one or more electronic circuits that perform various operations on and/or using data in the memory 106. Examples of the processor 102 include but are not limited to one or more of a central processing unit (CPU), a graphics processing unit (GPU), a field programmable gate array (FPGA), an accelerator, an accelerated processing unit (APU), and a digital signal processor (DSP). By way of example, the processor 102 includes one or more cores (e.g., processing units) that read and execute instructions (e.g., of a program), examples of which include to add, to move data, and to branch. In variations, the processor 102 includes just a single core while in other variations the processor 102 includes multiple cores. Processors having multiple cores (e.g., two or more separate processing units) on a single integrated circuit are commonly referred to as “multi-core processors.” The processor 102, the controller 104, and the memory 106, are operable to implement an operating system 108 and/or one or more applications 110.

The memory 106 is a device or system that is used to store information, such as for immediate use in a device, e.g., by the processor 102. In one or more implementations, the memory 106 corresponds to semiconductor memory where data is stored within memory cells on one or more integrated circuits. In at least one example, the memory 106 corresponds to or includes volatile memory, examples of which include random-access memory (RAM), dynamic random-access memory (DRAM), synchronous dynamic random-access memory (SDRAM), and static random-access memory (SRAM), to name just a few.

The memory 106 is packaged or configured in any of a variety of different manners. Examples of such packaging or configuring include as a dual in-line memory module (DIMM), a small outline DIMM (SO-DIMM), a registered DIMM (RDIMM), a non-volatile DIMM (NVDIMM), a ball grid array (BGA) memory permanently attached to (e.g., soldered to) a motherboard (or other printed circuit board), and so forth.

Examples of types of DIMMs include, but are not limited to, synchronous dynamic random-access memory (SDRAM), double data rate (DDR) SDRAM, double data rate 2 (DDR2) SDRAM, double data rate 3 (DDR3) SDRAM, double data rate 4 (DDR4) SDRAM, and double data rate 5 (DDR 5 ) SDRAM. In at least one variation, the memory 106 is configured as or includes a SO-DIMM or an RDIMM according to one of the above-mentioned standards, e.g., DDR, DDR2, DDR3, DDR4, and DDR5.

Alternatively or in addition, the memory 106 corresponds to or includes non-volatile memory, examples of which include flash memory, read-only memory (ROM), programmable read-only memory (PROM), erasable programmable read-only memory (EPROM), electronically erasable programmable read-only memory (EEPROM), phase change memory (PCM), and memristors, to name just a few.

Further examples of memory configurations include low-power double data rate (LPDDR), also known as LPDDR SDRAM, which is a type of synchronous dynamic random-access memory. In variations, LPDDR consumes less power than other types of memory and/or has a form factor suitable for mobile computers and devices, such as mobile phones. Examples of LPDDR include, but are not limited to, low-power double data rate 2 (LPDDR 2), low-power double data rate 3 (LPDDR 3), low-power double data rate 4 (LPDDR 4), and low-power double data rate 5 (LPDDR 5). It is to be appreciated that the memory 106 is configurable in a variety of ways without departing from the spirit or scope of the described techniques.

The controller 104 is a digital circuit that manages the flow of data, such as the flow of data to and from the memory 106. By way of example, the controller 104 includes logic to read and write to the memory 106 and interface with the processor 102. For instance, the controller 104 receives instructions from the processor 102 which involve accessing the memory 106 and providing data to the processor 102, e.g., for processing by the processor 102. When the processor 102 is scheduled to execute instructions associated with a process 112, for instance, the controller 104 allocates one or more portions 114 of the memory 106 (e.g., an address space) to the process 112. As the processor 102 executes the instructions associated with the process 112, the controller 104 accesses data in the respective portions 114 of the memory 106, e.g., the controller 104 reads and/or writes data at the respective portions 114 of the memory 106.

Broadly, the processes 112 correspond to one or more instructions that are executable by the processor 102, such as by using data stored in the memory 106. In variations, the processes 112 correspond to instructions associated with one or more computer programs, such as the operating system 108 and/or the applications 110. By way of example and not limitation, the processes 112 correspond to or include threads, tasks, workloads, and so forth.

Here, the system 100 also includes kernel 116 having driver(s) 118. The driver(s) 118 are depicted including an interrupt handler 120 which, in accordance with the described techniques, is program code or an algorithm executed by the processor 102 to handle interrupts due to errors in the memory 106. In at least one implementation, the interrupt handler 120 is included in a device driver associated with the processor 102, the controller 104, and/or the memory 106. In variations, the driver(s) 118 include numerous device drivers for various hardware components of the system 100, such as one or more device drivers for each of the processor 102, the controller 104, the memory 106, cryptography, and optional peripherals and other input/output (I/O) devices (not shown). In one or more implementations, one or more of those drivers include one or more interrupt handlers that are executable to handle one or more interrupts signaled by the hardware components of the system 100.

In one or more implementations, the kernel 116 is part of the operating system 108. For example, the kernel 116 is a computer program at the core of the operating system 108. In accordance with the described techniques, the kernel 116 facilitates interactions between hardware of the system 100 (e.g., the processor 102, the controller 104, the memory 106, etc.) and software (e.g., the applications 110 and/or various computer programs associated with the operating system 108). In at least one variation, the kernel 116 is a portion of operating system code that is resident (e.g., always resident) in the memory 106. Further, in some implementations, the kernel 116 is loaded into a separate portion of the memory 106, which is protected from access, such as from access by the applications 110. In this protected “kernel space,” the kernel 116 performs its tasks, such as running the processes 112 (e.g., on the processor 102), managing hardware devices, and handling interrupts. When running in or using this protected, kernel space, a computer program (e.g., a driver) runs in “kernel mode.” By way of contrast, the applications 110 use a portion of the memory 106 that is separate from the “kernel space.” This separate portion is referred to as the “user space,” and when running in or using this separate space, a computer program (e.g., a driver or an application) runs in “user mode.”

In one or more implementations, the driver(s) 118 include one or more device drivers. Broadly, a device driver is a computer program that operates or controls a particular type of device that is attached to a computer, and a device driver provides a software interface to hardware devices. This enables the applications 110 and other computer programs to access hardware functions of respective hardware. In one or more implementations, the driver(s) 118 communicate with respective hardware devices through a bus and/or another communications subsystem to which the hardware connects. When a calling program invokes a routine in a driver, the driver issues a command to the device over the bus or communications subsystem, i.e., to “drive” the device. Over the bus and/or communications subsystem, the devices send data back to the drivers 118. In accordance with the described techniques, for example, the devices send data indictive of interrupts—which correspond to interruptions to operation of those devices—back to the drivers to invoke interrupt handling routines.

As noted above, the driver(s) 118 include device drivers for controlling the processor 102 and the memory 106, and the at least one of those device drivers includes the interrupt handler 120 to handle errors in the memory 106 as discussed above and below. In one or more implementations, the interrupt handler 120 is a routine or computer program of a driver 118 (e.g., for the processor 102 and/or the memory 106) that is executable by the processor 102 to handle errors in the memory 106 (e.g., uncorrectable errors). It is to be appreciated that in variations, the interrupt handler 120 is implemented in other ways such as logic in firmware of a hardware component (e.g., the processor 102 and/or the memory 106), in an in-memory processor (e.g., a processing-in-memory (PIM) component), and/or in hardware.

In accordance with the described techniques, the interrupt handler 120 improves how uncorrectable errors in memory 106 are handled relative to conventional techniques. In conventional approaches, when an uncorrectable error is detected in memory, those errors are treated as fatal events. For instance, conventional systems freeze data paths to prevent corrupted data from escaping a hardware device, e.g., the processor 102. Additionally or alternatively, the drivers of conventional systems issue a complete reset of the processor 102 to return the processor 102 to a fully working state and/or cause a warm reboot of the system. Conventionally configured drivers also identify the portions of memory (e.g., the pages) where the uncorrectable errors are located and retire those portions from being used. Due to such operations, conventional approaches cause all the applications 110 running on top of (e.g., using) the processor 102 to be terminated, and in order to resume those applications 110, they need to be restarted after the processor 102 is returned to a working state.

In contrast to these conventional approaches, the described techniques do not require all the applications 110 and/or processes 112 to be terminated responsive to an uncorrectable error 122 in the memory 106. Instead, the interrupt handler 120 limits the impact of uncorrectable errors to the processes 112 that consume the portion 114 of memory 106 where the uncorrectable error 122 is located, and the described techniques treat the error as a “deferred” error rather than a fatal error. This enables the system 100 to continue executing the processes 112 that consume portions 114 of memory 106 where uncorrectable errors are not located.

In accordance with the described techniques, the uncorrectable error 122 is detected in the memory 106. For instance, the memory 106 detects the uncorrectable error 122 in the memory 106. By way of example and not limitation, uncorrectable errors in the memory 106 are caused by various events, such as a stuck bit, a particle strike (e.g., due to background radiation including neutrons from cosmic ray secondaries), and so forth. Faults in the memory 106 due to such events can be permanent, intermittent, and/or transient, such as across nodes in data centers. Additionally, multi-bit faults in DRAM due to such events can be permanent. An uncorrectable error 122 can be present in the memory 106 due to a variety of events without departing from the spirit or scope of the described techniques.

Responsive to detection of the uncorrectable error 122, the memory 106 issues an interrupt request 124. An interrupt request is commonly abbreviated as or otherwise notated as “IRQ.” In one or more implementations, the interrupt request 124 is a hardware signal sent by the memory 106 to the processor 102, e.g., over one or more buses which connect the processor 102 and the memory 106.

In contrast to conventional techniques that, responsive to the interrupt request 124, report the uncorrectable error 122 to drivers as a fatal error event which causes a complete reset or a warm reboot, the processor 102 is instead configured to defer handling of the uncorrectable error 122. For instance, responsive to the interrupt request 124, the processor 102 converts the uncorrectable error 122 into a deferred error, such as by marking the uncorrectable error 122 as a deferred error. In at least one variation, the processor 102 waits to provide a deferred interrupt signal 126 to the driver(s) 118 until the portion 114 of the memory 106 with the uncorrectable error 122 is accessed (e.g., “consumed”) by one of the processes 112. Based on the deferred interrupt signal 126, the interrupt handler 120 of the driver(s) 118 is executed by the processor 102 to handle the uncorrectable error 122—which triggered the interrupt request 124.

Based on receiving the deferred interrupt signal 126 and/or the interrupt request 124 triggered by the uncorrectable error 122, the interrupt handler 120 identifies which process 112 accesses the portion 114 of the memory 106 having the uncorrectable error 122, which has been marked as a deferred error. In one or more implementations, for instance, the interrupt handler 120 causes a look-up for an identifier (e.g., in a record, table, log, or database of interrupts), where the identifier identifies an address space of the memory 106 allocated to a process 112.

Once the process 112 that accesses the uncorrectable error 122 marked as the deferred error is identified, the interrupt handler 120 causes termination of the process 112. Notably, though, the interrupt handler 120 causes termination of the process 112 without terminating other processes 112, e.g., without terminating the other processes 112 that are not accessing portions 114 of the memory 106 with an uncorrectable error 122 marked as a deferred error. To terminate the process 112, in one or more scenarios, the interrupt handler 120 provides a signal to a “user mode” driver, which indicates that the process 112 has accessed the uncorrectable error 122 marked as a deferred error and also indicates to terminate the process 112. A “user mode” driver handles software interrupts as opposed to the hardware interrupts handled by kernel mode drivers, e.g., the driver(s) 118 of the processor 102 and the memory 106 in the kernel. Alternatively or additionally, the interrupt handler 120 issues a bus error signal (e.g., SIGBUS) to terminate the process 112 from the driver(s) 118 in the kernel mode directly.

The driver(s) 118 then initiate a recovery process, which in one or more variations includes recovering the portions of the processor 102 (e.g., cores) executing the process 112 (e.g., the portions accessing data in the portion 114 of the memory 106 with the uncorrectable error 122) and includes recovering one or more additional resources of the system 100. In one or more implementations, the particular recovery process performed by the interrupt handler 120 is based on a type of process 112 that accessed (e.g., consumed) the portion 114 of memory 106 with the uncorrectable error 122 marked as deferred. For example, the interrupt handler 120 may select the recovery process from a plurality of different recovery processes associated with different types of processes 112 that access the portion 114 of memory 106 with the uncorrectable error 122 marked as deferred. In one or more implementations, for instance, the recovery process performed depends on whether the process 112 corresponds to a compute engine, a direct memory access (DMA) engine, or a multimedia engine, to name a few. It is to be appreciated that in variations, a recovery process, differs based on different types of processes.

In scenarios where the process 112 that accessed the portion 114 of memory 106 with the uncorrectable error 122 marked as a deferred error corresponds to a compute engine, for instance, the driver(s) 118 stop execution of one or more computing operations associated with the process 112 of the compute engine. The driver(s) 118 remove mappings of user mode queues assigned to the process 112 for command submission. Broadly, user mode queues are configured to allow applications 110 to submit commands from user space for processing by one or more hardware components, such as the processor 102. The driver(s) 118 then reestablish the mappings to the user mode queues so that those user mode queues are subsequently accessible to be assigned to the process 112. In scenarios where removal of the mappings or reestablishment of the mappings fails, in one or more variations, the driver(s) 118 issue a “lightweight” reset—not a full reset of the processor 102. Such a “lightweight” reset causes a compute engine to be reset and reinitialized so that the compute engine is subsequently capable of submitting instructions which cause processes 112 to be executed using the processor 102, the memory 106, and so on.

In scenarios where the process 112 that accessed the portion 114 of memory 106 with the uncorrectable error 122 marked as a deferred error corresponds to a DMA engine, the driver(s) 118 cause a hardware reinitialization of a system DMA instance that accessed the portion of the memory 106 with the uncorrectable error 122. In scenarios where hardware reinitialization corresponding to the system DMA engine fails, in one or more variations, the driver(s) 118 issue a lightweight reset—not a full reset of the processor 102. The lightweight reset causes the DMA engine to be reset and reinitialized so that the DMA engine is subsequently capable of submitting instructions which cause processes 112 to be executed using the processor 102, the memory 106, and so on.

In scenarios where the process 112 that accessed the portion 114 of memory 106 with the uncorrectable error 122 marked as a deferred error corresponds to a multimedia engine, the driver(s) 118 reinitialize the multimedia engine that accessed the portion of the memory 106 with the uncorrectable error 122. In scenarios where hardware reinitialization corresponding to the multimedia engine fails, in one or more variations, the driver(s) 118 issue a lightweight reset—not a full reset of the processor 102. The lightweight reset causes a multimedia engine to be reset and reinitialized so that the multimedia engine is subsequently capable of submitting instructions which cause processes 112 to be executed using the processor 102, the memory 106, and so on.

In one or more implementations, the driver(s) 118 also invoke a page retirement workflow, e.g., a “bad page” retirement workflow. This prevents the portion of the memory 106 with the uncorrectable error 122 marked as deferred from subsequently being used, e.g., that portion of the memory 106 is not subsequently allocated to one or more processes 112. Additionally or alternatively, the driver(s) 118 cause the uncorrectable error 122 marked as the deferred error to be logged in a system log associated with the kernel 116. Further, the driver(s) 118 signal EEPROM to conduct further analysis and/or diagnosis of the error.

Having discussed example systems for handling uncorrectable errors in memory, consider the following example procedures.

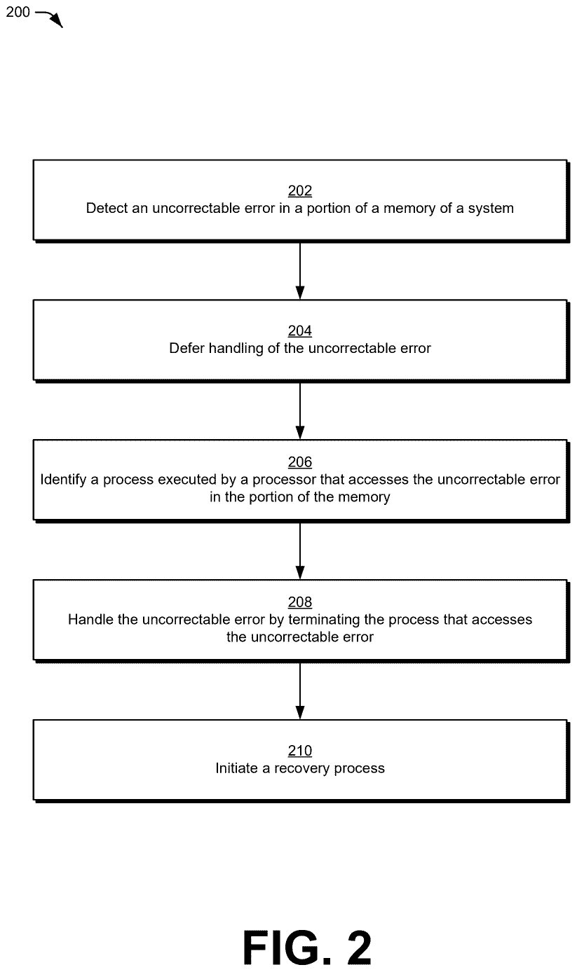

FIG. 2 depicts a procedure in an example 200 implementation of handling uncorrectable errors in memory.

An uncorrectable error is detected in a portion of a memory of a system (block 202). By way of example, the memory 106 detects the uncorrectable error 122 in the memory 106. By way of example and not limitation, uncorrectable errors in the memory 106 are caused by various events, such as a stuck bit, a particle strike (e.g., due to background radiation including neutrons from cosmic ray secondaries), and so forth. Faults in the memory 106 due to such events can be permanent, intermittent, and/or transient, such as across nodes in data centers. Additionally, many multi-bit faults in DRAM due to such events can be permanent. An uncorrectable error 122 can be present in the memory 106 due to a variety of events without departing from the spirit or scope of the described techniques.

Handling of the uncorrectable error is deferred (block 204). By way of example, responsive to detection of the uncorrectable error 122, the memory 106 issues an interrupt request 124. In contrast to conventional techniques that, responsive to the interrupt request 124, report the uncorrectable error 122 to drivers as a fatal error event which causes a complete reset or a warm reboot, the processor 102 is instead configured to defer handling of the uncorrectable error 122. For instance, responsive to the interrupt request 124, the processor 102 converts the uncorrectable error 122 into a deferred error, such as by marking the uncorrectable error 122. In at least one variation, the processor 102 waits to provide a deferred interrupt signal 126 to a driver(s) 118 of the memory 106 until the portion 114 of the memory 106 with the uncorrectable error 122 is accessed by (e.g., “consumed” by) one of the processes 112. Based on the deferred interrupt signal 126, the interrupt handler 120 of the driver 118 of the memory 106 is executed by the processor 102 to handle the uncorrectable error 122—which triggered the interrupt request 124.

A process executed by a processor that accesses the uncorrectable error in the portion of the memory is identified (block 206). By way of example, based on receiving the deferred interrupt signal 126 and/or the interrupt request 124 triggered by the uncorrectable error 122, the interrupt handler 120 identifies which process 112 accesses the portion 114 of the memory 106 having the uncorrectable error 122, which has been marked as a deferred error. In one or more implementations, for instance, the interrupt handler 120 causes a look-up for an identifier (e.g., in a record of interrupts), where the identifier identifies an address space of the memory 106 allocated to a process 112.

The uncorrectable error is handled by terminating the process that accesses the uncorrectable error (block 208). By way of example, once the process 112 that accesses the uncorrectable error 122 marked as the deferred error is identified, the interrupt handler 120 causes termination of the process 112. Notably, though, the interrupt handler 120 causes termination of the process 112 without terminating other processes 112, e.g., without terminating the other processes 112 that are not accessing portions 114 of the memory 106 with an uncorrectable error 122 marked as a deferred error. To terminate the process 112, in one or more scenarios, the interrupt handler 120 provides a signal to a “user mode” driver, which indicates that the process 112 has accessed the uncorrectable error 122 marked as a deferred error and indicates to terminate the process 112. A “user mode” driver handles software interrupts as opposed to the hardware interrupts handled by kernel mode drivers (e.g., the driver(s) 118 of the memory 106 in the kernel). Alternatively or additionally, the interrupt handler 120 issues a bus error signal (e.g., SIGBUS) to terminate the process 112 from the driver 118 in the kernel mode directly.

A recovery process is initiated (block 210). By way of example, the driver(s) 118 then initiate a recovery process, which in one or more variations includes recovering the portions of the processor 102 (e.g., cores) executing the process 112 (e.g., the portions accessing data in the portion 114 of the memory 106 with the uncorrectable error 122) and includes recovering one or more additional resources of the system 100. In one or more implementations, the particular recovery process performed by the interrupt handler 120 is based on a type of process 112 that accessed (e.g., consumed) the portion 114 of memory 106 with the uncorrectable error 122 marked as deferred. In one or more implementations, for instance, the recovery process performed depends on whether the process 112 corresponds to a compute engine, a direct memory access (DMA) engine, or a multimedia engine, to name a few. It is to be appreciated that in variations, a recovery process, differs based on different types of processes.

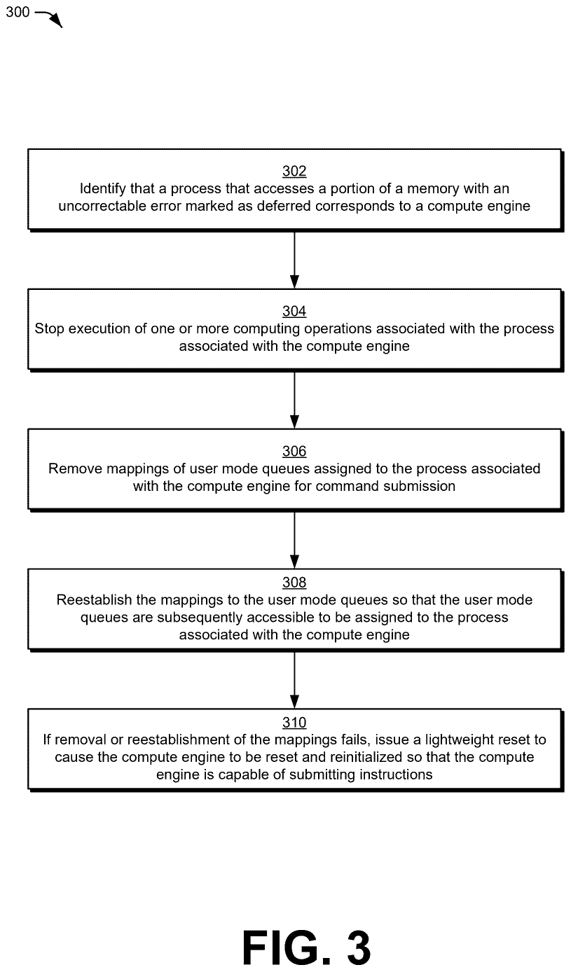

FIG. 3 depicts a procedure in another example 300 implementation of handling uncorrectable errors in memory.

A process that accesses a portion of a memory with an uncorrectable error marked as deferred is identified as corresponding to a compute engine (block 302), and execution is stopped for one or more computing operations associated with the process associated with the compute engine (block 304). By way of example, in scenarios where the process 112 that accessed the portion 114 of memory 106 with the uncorrectable error 122 marked as a deferred error corresponds to a compute engine, the driver(s) 118 stop execution of one or more computing operations associated with the process 112 of the compute engine.

Mappings of user mode queues assigned to the process associated with the compute engine are removed for command submission (block 306). By way of example, the driver(s) 118 remove mappings of user mode queues assigned to the process 112 for command submission. Broadly, user mode queues are configured to allow applications 110 to submit commands from user space for processing by one or more hardware components, such as the processor 102.

The mappings to the user mode queues are reestablished so that the user mode queues are subsequently accessible to be assigned to the process associated with the compute engine (block 308). By way of example, the driver(s) 118 then reestablish the mappings to the user mode queues so that those user mode queues are subsequently accessible to be assigned to the process 112. In scenarios where removal of the mappings or reestablishment of the mappings fails, in one or more variations, the driver(s) 118 issue a “lightweight” reset—not a full reset of the processor 102. Such a “lightweight” reset causes a compute engine to be reset and reinitialized so that the compute engine is subsequently capable of submitting instructions which cause processes 112 to be executed using the processor 102, the memory 106, and so on.

Optionally, if the removal or reestablishment of the mappings fail, a lightweight reset is issued to cause the compute engine to be reset and reinitialized so that the compute engine is subsequently capable of submitting instructions (block 310). By way of example, in scenarios where removal of the mappings or reestablishment of the mappings fails, the driver(s) 118 may issue a “lightweight” reset—not a full reset of the processor 102. Such a “lightweight” reset causes a compute engine to be reset and reinitialized so that the compute engine is subsequently capable of submitting instructions which cause processes 112 to be executed using the processor 102, the memory 106, and so on.

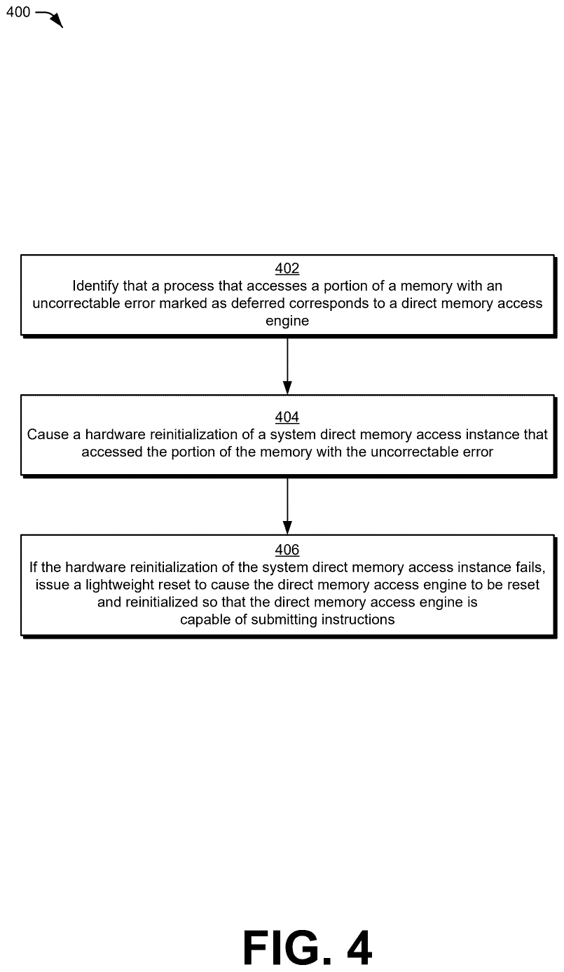

FIG. 4 depicts a procedure in another example 400 implementation of handling uncorrectable errors in memory.

A process that accesses a portion of a memory with an uncorrectable error marked as deferred is identified as corresponding to a DMA engine (block 402), and a hardware reinitialization is caused for a system direct memory access instance that accessed the portion of the memory with the uncorrectable error (block 404). By way of example, in scenarios where the process 112 that accessed the portion 114 of memory 106 with the uncorrectable error 122 marked as a deferred error corresponds to a direct memory access engine, the driver(s) 118 cause a hardware reinitialization of a system DMA instance that accessed the portion of the memory 106 with the uncorrectable error 122.

Optionally, if the hardware reinitialization of the system direct memory access instance fails, a lightweight reset is issued to cause the direct memory access engine to be reset and reinitialized so that the direct memory access engine is subsequently capable of submitting instructions (block 406). By way of example, in scenarios where hardware reinitialization corresponding to the system DMA engine fails, the driver(s) 118 issue a lightweight reset—not a full reset of the processor 102. The lightweight reset causes the DMA engine to be reset and reinitialized so that the DMA engine is subsequently capable of submitting instructions which cause processes 112 to be executed using the processor 102, the memory 106, and so on.

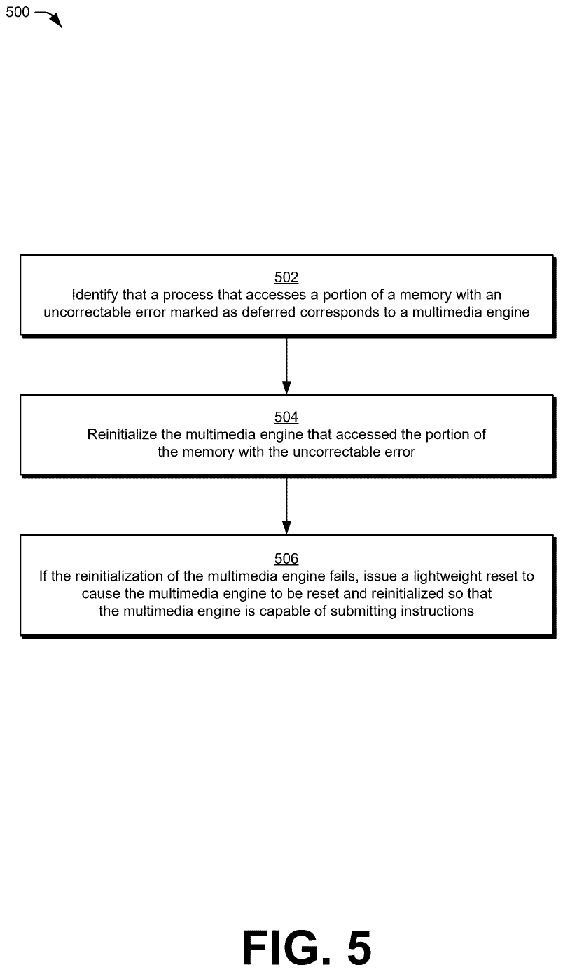

FIG. 5 depicts a procedure in another example 500 implementation of handling uncorrectable errors in memory.

A process that accesses a portion of a memory with an uncorrectable error marked as deferred is identified as corresponding to a multimedia engine (block 502), and the multimedia engine that accessed the portion of the memory with the uncorrectable error is reinitialized (block 504). By way of example, in scenarios where the process 112 that accessed the portion 114 of memory 106 with the uncorrectable error 122 marked as a deferred error corresponds to a multimedia engine, the driver(s) 118 reinitialize the multimedia engine that accessed the portion of the memory 106 with the uncorrectable error 122.

Optionally, if the reinitialization of the multimedia engine fails, a lightweight reset is issued to cause the multimedia engine to be reset and reinitialized so that the multimedia engine is capable of submitting instructions (block 506). By way of example, in scenarios where hardware reinitialization corresponding to the multimedia engine fails, in one or more variations, the driver(s) 118 issue a lightweight reset—not a full reset of the processor 102. The lightweight reset causes a multimedia engine to be reset and reinitialized so that the multimedia engine is subsequently capable of submitting instructions which cause processes 112 to be executed using the processor 102, the memory 106, and so on.

It should be understood that many variations are possible based on the disclosure herein. Although features and controls are described above in particular combinations, each feature or control is usable alone without the other features and controls or in various combinations with or without other features and controls.

The various functional units illustrated in the figures and/or described herein (including, where appropriate, the processor 102, the controller 104, the memory 106, the operating system 108, the applications 110, the kernel 116, the driver(s) 118, and the interrupt handler 120) are implemented in any of a variety of different manners such as hardware circuitry, software or firmware executing on a programmable processor, or any combination of two or more of hardware, software, and firmware. The methods provided are implemented in any of a variety of devices, such as a general purpose computer, a processor, or a processor core. Suitable processors include, by way of example, a general purpose processor, a special purpose processor, a conventional processor, a digital signal processor (DSP), a graphics processing unit (GPU), a parallel accelerated processor, a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

In one or more implementations, the methods and procedures provided herein are implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A system comprising:
a memory to detect an uncorrectable error in a portion of the memory and issue an interrupt request;
a processor to convert the uncorrectable error to a deferred error responsive to receiving the interrupt request issued by the memory; and
an interrupt handler to identify a process that accesses the uncorrectable error in the portion of the memory and handle the uncorrectable error by terminating the process that accesses the uncorrectable error.

2. The system of claim 1, wherein the interrupt handler terminates the process that accesses the uncorrectable error without terminating other processes that are not accessing the uncorrectable error in the portion of the memory.

3. The system of claim 1, wherein the processer converts the uncorrectable error to the deferred error by marking the uncorrectable error as a deferred error.

4. The system of claim 1, wherein the interrupt handler identifies the process that accesses the uncorrectable error by causing a look-up for an identifier in a record of interrupts, wherein the identifier identifies an address space of the memory allocated to respective processes.

5. The system of claim 1, wherein the interrupt handler terminates the process by providing a signal to a user mode driver to terminate the process.

6. The system of claim 1, wherein the interrupt handler is further configured to initiate a recovery process after terminating the process that accesses the uncorrectable error.

7. The system of claim 6, wherein the interrupt handler is further configured to select the recovery process from a plurality of recovery processes based on a type of the process that accessed the uncorrectable error.

8. A method comprising:
detecting an uncorrectable error in a portion of a memory of a system;
deferring handling of the uncorrectable error;
identifying a process executed by a processor that accesses the uncorrectable error in the portion of the memory; and
handling the uncorrectable error by terminating the process that accesses the uncorrectable error.

9. The method of claim 8, wherein the deferring comprises converting the uncorrectable error into a deferred error by marking the uncorrectable error.

10. The method of claim 8, wherein the handling comprises terminating the process that is accessing the uncorrectable error without terminating other processes that are not accessing the uncorrectable error in the portion of the memory.

11. The method of claim 8, wherein the identifying comprises causing a look-up for an identifier in a record of interrupts, wherein the identifier identifies an address space of the memory allocated to respective processes.

12. The method of claim 8, further comprising initiating a recovery process to recover portions of the processor executing the process.

13. The method of claim 12, wherein recovery process is selected from a plurality of recovery processes based on a type of the process that accessed the uncorrectable error.

14. The method of claim 13, wherein the process is associated with a compute engine, and wherein the recovery process comprises:
stopping execution of one or more computing operations associated with the process associated with the compute engine;
removing mappings of user mode queues assigned to the process associated with the compute engine for command submission; and
reestablishing the mappings to the user mode queues so that the user mode queues are subsequently accessible to be assigned to the process associated with the compute engine.

15. The method of claim 14, wherein if removal or reestablishment of the mappings fail, issuing a lightweight reset to cause the compute engine to be reset and reinitialized so that the compute engine is capable of submitting instructions.

16. The method of claim 13, wherein the process is associated with a direct memory access engine, and wherein the recovery process comprises causing a hardware reinitialization of a system direct memory access instance that accessed the portion of the memory with the uncorrectable error, and wherein if the hardware reinitialization of the system direct memory access instance fails, issuing a lightweight reset to cause the direct memory access engine to be reset and reinitialized so that the direct memory access engine is subsequently capable of submitting instructions.

17. The method of claim 13, wherein the process is associated with a multimedia engine, and wherein the recovery process comprises reinitializing the multimedia engine that accessed the portion of the memory with the uncorrectable error, and wherein if the reinitialization of the multimedia engine fails, issuing a lightweight reset to cause the multimedia engine to be reset and reinitialized so that the multimedia engine is capable of submitting instructions.

18. A method comprising:
identifying a process that accesses a portion of a memory with an uncorrectable error marked as deferred;
terminating the process without terminating other processes that are not accessing the uncorrectable error in the portion of the memory; and
selecting a recovery process from a plurality of recovery processes based on a type of the process.

19. The method of claim 18, wherein the process is associated with a compute engine, and wherein the recovery process comprises:
stopping execution of one or more computing operations associated with the process associated with the compute engine;
removing mappings of user mode queues assigned to the process associated with the compute engine for command submission; and
reestablishing the mappings to the user mode queues so that the user mode queues are subsequently accessible to be assigned to the process associated with the compute engine.

20. The method of claim 18, wherein the process is associated with a direct memory access engine, and wherein the recovery process comprises causing a hardware reinitialization of a system direct memory access instance that accessed the portion of the memory with the uncorrectable error, and wherein if the hardware reinitialization of the system direct memory access instance fails, issuing a lightweight reset to cause the direct memory access engine to be reset and reinitialized so that the direct memory access engine is subsequently capable of submitting instructions.
